(19) United States
(12) Patent Application Publication
(10) Pub. No.: US 2006/0021037 A1
(43) Pub. Date: Jan. 26, 2006

(54) Apparatus, system, and method for protecting content using fingerprinting and real-time evidence gathering

(75) Inventors: Oscar V. Zhuk, Bellevue, WA (US); Glenn A. Morten, Bellevue, WA (US)

Correspondence Address: DARBY & DARBY P.C., P. O. BOX 5257, NEW YORK, NY, 10150-5257, US

(73) Assignee: Widevine Technologies, Inc., Seattle, WA (US)

(21) Appl. No.: 11/150,357

(22) Filed: Jun. 10, 2005

Related U.S. Application Data
(60) Provisional application No. 60/582,735, filed on Jun. 24, 2004.

(51) Int. Cl. G06F 12/14

(52) U.S. Cl. 726/22

(57) ABSTRACT

An apparatus, system, and method for protecting digital information from unauthorized access are described. The invention is configured to employ digital fingerprinting, pattern recognition, and real-time tamper evidence gathering to monitor for unauthorized access. When an unauthorized access is detected, an appropriate response that may be based on business rules is provided that may include termination of execution of a content player. The invention monitors over time a predetermined set of parameters associated with at least one process on a client device to detect a change in state. The state change is employed to create a fingerprint for the process. Statistical analysis is then applied to additional data collected to determine whether the additional data indicates unauthorized behavior.

### CROSS-REFERENCE TO RELATED APPLICATIONS

The present application hereby makes reference to and claims priority under 35 U.S.C. § 119(e) from Provisional Patent Application No. 60/582,735 entitled “Apparatus, System, And Method For Protecting Content Using Fingerprinting And Real-Time Evidence Gathering,” filed on Jun. 24, 2004, which is further hereby incorporated within.

### FIELD OF THE INVENTION

The invention relates generally to remote computing security, and more particularly but not exclusively to providing an apparatus, system, and method for protecting digital information from unauthorized access including use of digital fingerprinting, pattern recognition, and tamper evidence gathering.

### BACKGROUND OF THE INVENTION

Of all the industries that have been revolutionized by the rise of digital technology and the Internet, few have been swept so greatly as the “content” industries, such as producers and providers of music, movies, pay per view (PPV), Video on Demand (VoD), interactive media, and the like. The Internet has made widespread distribution of such content easier than ever. Unfortunately, the digital era also has a serious downside for the content producers and providers. It has made it easier for some consumers to get access to the content without paying for it.

There have been several attempts towards protecting the content. For example, the content may be encrypted while it is delivered over a network, such as the Internet. The content may also be encrypted while it resides on a media device such as a CD, DVD, and the like. However, once the content is decrypted and made available to the consumer, say at a client computing device during playback, it is exposed to unauthorized access. Such exposed content may be improperly accessed, or hacked, employing a variety of techniques.

For example, the content may be hacked from “within” the client computing device. That is, a user of the client computing device may attempt to improperly access the content employing any of a variety of mechanisms, including hacking a screen display, using a screen scraper tool, hacking a video and/or an audio device, hacking a content stream, and the like. The user may even attempt to employ a content stream scraper to improperly access the content for unauthorized use.

The content may similarly be improperly accessed by hacking the client computing device from “outside” of the client computing device. That is, by employing a variety of hacking tools and methods, an outside hacker may attempt to penetrate the client computing device, transfer content protection information into an unprotected location, and then employ the protection information to copy improperly the content. Thus, it is with respect to these considerations and others that the present invention has been made.

### BRIEF DESCRIPTION OF THE DRAWINGS

Non-limiting and non-exhaustive embodiments of the invention are described with reference to the following drawings. In the drawings, like reference numerals refer to like parts throughout the various figures unless otherwise specified.

For a better understanding of the invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a client device that may be included in a system implementing the invention;

FIG. 3 illustrates one embodiment of a list of parameters that may be analyzed by the invention in determining fingerprints and in real-time evidence gathering;

FIG. 4 illustrates a logical flow diagram generally showing one embodiment of an overview process for detecting an unauthorized behavior on a computing device;

FIG. 5 illustrates a logical flow diagram generally showing one embodiment of a process for gathering pre-selected parameters of processes associated with the computing device

FIG. 6 illustrates a logical flow diagram generally showing one embodiment of a process for employing delta events analysis to determine fingerprints for at least a subset of the processes;

FIG. 7 illustrates a logical flow diagram generally showing one embodiment of a process for performing pattern classification of the determined fingerprints using entropy analysis;

FIG. 8 illustrates a schematic representation generally showing one embodiment of a process of transforming vectors to determine a score output; and

FIG. 9 illustrates a schematic representation generally showing one embodiment of a process of transforming matrices to determine several score outputs, in accordance with the invention.

### DETAILED DESCRIPTION OF THE INVENTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods or devices. Accordingly, the invention may take the form of an entirely hardware embodiment, an entirely software embodiment or an embodiment combining software and hardware aspects. The following detailed description is, therefore, not to be taken in a limiting sense.

Briefly stated, the invention is directed towards an apparatus, system, and method for protecting digital information from unauthorized access. The invention is configured to employ digital fingerprinting, pattern recognition, and real-time tamper evidence gathering to monitor for unauthorized access and provide an appropriate response. Digital fingerprinting may be based, at least in part, on a behavior of selected computer processes. The invention is directed to protecting digital media from outside, and/or inside unauthorized access, and similar unauthorized actions at a client-side device. In one embodiment, the client-side device includes a digital computer, a set-top box (STB), and the like.

The invention employs several mechanisms, including vector analysis, cluster analysis, statistical analysis, fuzzy logic, neural logic theory, decision-making, optimization theory, and the like. The invention may combine at least some of these mechanisms to provide a pattern recognition system for detecting unauthorized actions. The invention is configured to create and process a wide spectrum of different data, including, but not limited to data that may be determined to be normal, data that may be determined to be abnormal (sometimes, also called ‘bad,’ or unauthorized behavior), semi-repetitious, uncertain data, and fuzzy data from which patterns of behavior may be created. The created patterns may be classified as normal (good) data patterns, abnormal (bad) data patterns that may be potentially unauthorized, and the like. Such patterns are employed because it is often impractical for a typical hacker to maintain such normal patterns for a system, process, and the like, while the hacker is attempting to perform a hack.

In addition, by employing the invention, a hacker may be detected relatively quickly making it more likely that content can be secured even where the system, process, application, or the like, may have been compromised. While hackers may generally compromise a system and alter its software, it is unlikely that the system's process behavior will be the same. Thus, monitoring of process behavior may be highly effective against hackers. Moreover, as the system's process behavior changes, the likelihood that the hacker may be able to complete a hack before being detected is greatly reduced.

The invention may be employed in a variety of configurations, including, but not limited to intrusion detection systems, devices configured to detect tampering or unauthorized data modification, dynamic and/or static pattern, image recognition systems, devices configured to detect abnormal behavior from a computing device, STB, and similar devices. Moreover, the invention may be configured to reside on the client computing device, in at least one embodiment. In that configuration, monitoring for unauthorized behavior may be performed even when the client computing device may not be in communication with a network. The invention is not limited to merely residing on the client computing device, however. For example, the invention may reside on another computing device, across multiple computing devices, and the like, without departing from the scope or spirit of the invention.

### Illustrative Environment

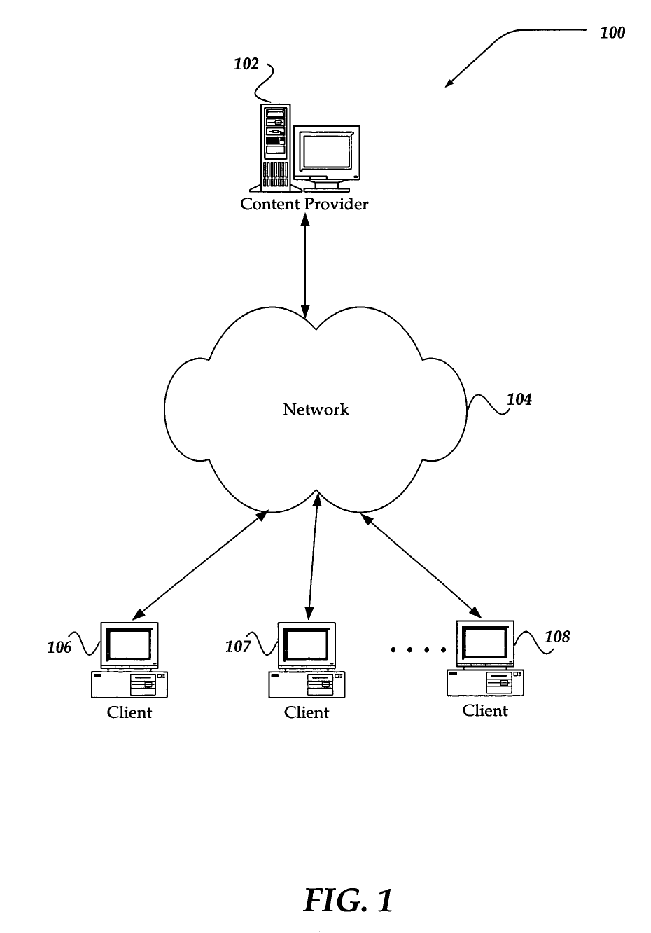

FIG. 1 shows a functional block diagram illustrating one embodiment of operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes content provider 102, network 104, and clients 106-108. Network 104 is in communication with content provider 102 and clients 106-108.

Content provider 102 includes computing devices configured for use by producers, developers, and owners of media content that can be distributed to client devices 106-108. Such content, includes, but is not limited to motion pictures, movies, videos, music, PPV, VoD, interactive media, audios, still images, text, graphics, and other forms of digital content directed towards a user of a client device, such as client devices 106-108. Content provider 102 may also include businesses, systems, and the like that obtain rights from a content owner to copy and distribute the content. Content provider 102 may obtain the rights to copy and distribute from one or more content owners. Content provider 102 may repackage, store, and schedule content for subsequent sale, distribution, and license to other content providers, users of client devices 106-108, and the like.

Although illustrated as employing network 104 to communicate content to client devices 106-108, the invention is not so limited. For example content provider 102 may employ virtually any mechanism to communicate content, including, but not limited to a data communications line, virtually any storage device, including a CD, a DVD, floppy diskette, magnetic tape, and the like. The content may be encrypted using any of a variety of encryption techniques. Similarly, the content may also be unencrypted.

Devices that may operate as content provider 102 include personal computers desktop computers, multiprocessor systems, microprocessor-based or programmable consumer electronics, network PCs, servers, and the like.

Network 104 is configured to couple one computing device to another computing device to enable them to communicate. Network 104 is enabled to employ any form of computer readable media for communicating information from one electronic device to another. Also, network 104 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 104 includes any communication method by which information may travel between client devices 106-108 and content provider 102.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

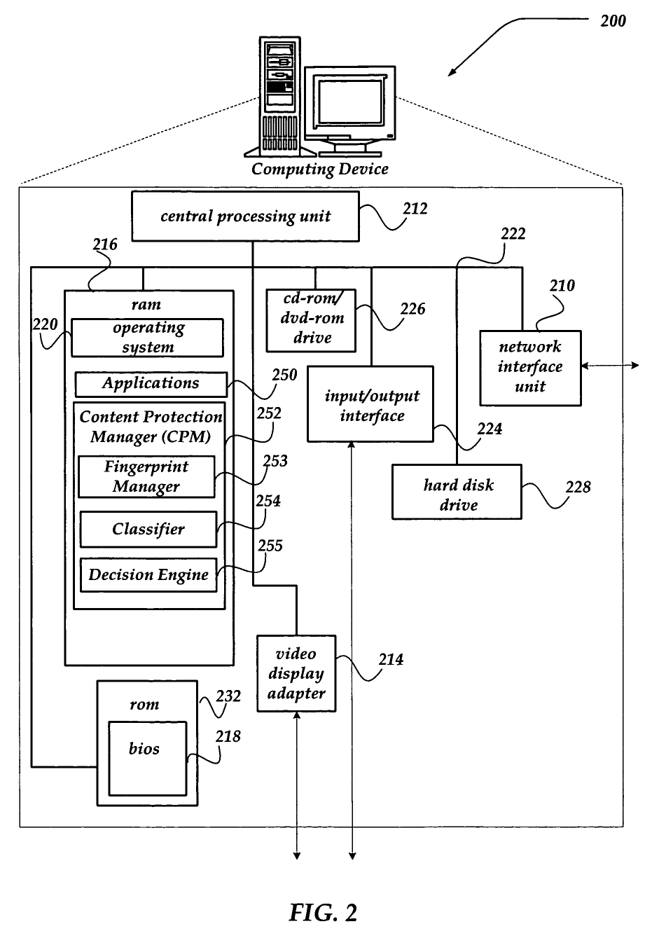

Client devices 106-108 may include virtually any computing device capable of receiving content over a network, such as network 104, from another computing device, such as content provider 102. Client devices 106-108 may also include any computing device capable of receiving the content employing other mechanisms, including, but not limited to CDs, DVDs, tape, electronic memory devices, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Client devices 106-108 may also be any device that is capable of connecting using a wired or wireless communication medium such as a PDA, POCK-ET PC, wearable computer, and any other device that is equipped to communicate over a wired and/or wireless communication medium to receive and play content. Similarly, client devices 106-108 may employ any of a variety of devices to enjoy such content, including, but not limited to, a computer display system, an audio system, a jukebox, set top box (STB), a television, video display device, and the like. Client devices 106-108 may be implemented employing a client device such as described in more detail below, in conjunction with FIG. 2.

Client devices 106-108 may include a client that is configured to enable an end-user to receive content and to play the received content. The client may also provide other actions, including, but not limited to, enabling other components of the client device to execute, enable an interface with another component, device, the end-user, and the like.

Client devices 106-108 may further receive a Content Protection Management (CPM) component, such as described in more detail below. The CPM component may be configured to monitor a characteristic of a behavior of the client device, and when a behavior is determined to be an abnormal (bad or unauthorized) behavior, the CPM component may enable an action to protect the content from a potentially unauthorized action. Such actions may include any of a variety of predetermined actions based on a policy, a rule, or the like, including turning off a network connection, turning off one or more processes, destroying or otherwise inhibiting access to content, providing a message to an end-user of the computing device, an owner of the content, or the like.

Illustrative Computing Device

FIG. 2 shows one embodiment of a computing device, according to one embodiment of the invention. Computing device 200 may include many more components than those shown. The components shown, however, are sufficient to disclose an illustrative embodiment for practicing the invention. Computing device 200 may represent, for example, client devices 106-108 of FIG. 1.

Computing device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of computing device 200. Any general-purpose operating system may be employed. Basic input/output system (“BIOS”) 218 is also provided for controlling the low-level operation of computing device 200. As illustrated in FIG. 2, computing device 200 also can communicate with the Internet, or some other communications network, such as network 104 in FIG. 1, via network interface unit 210, which is constructed for use with various communication protocols including the TCP/IP protocol. Network interface unit 210 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

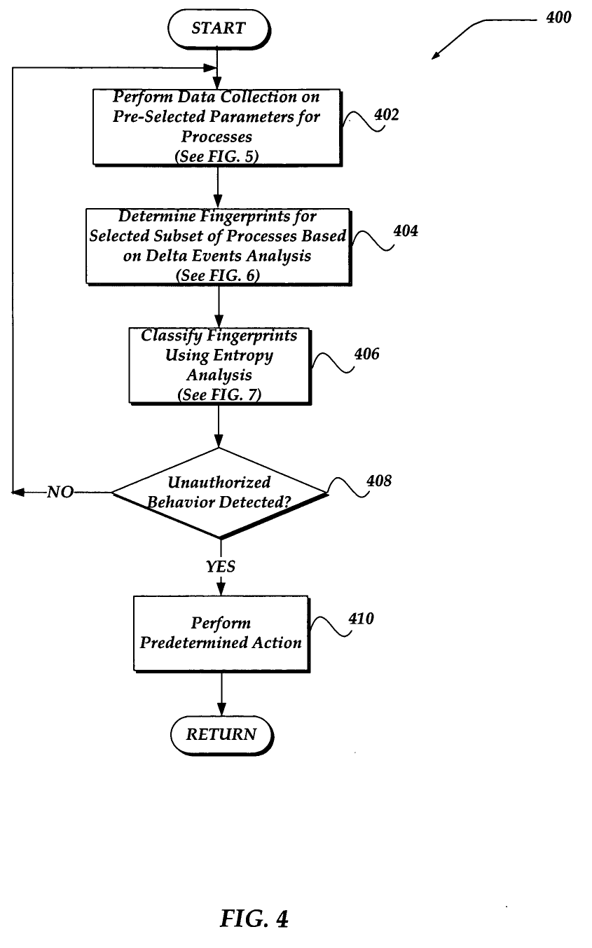

The mass memory also stores program code and data. One or more applications 250 are loaded into mass memory and run on operating system 220. Examples of application programs may include, but is not limited to transcoders, schedulers, calendars, database programs, word processing programs, HTTP programs, audio players, video players, VoD players, decoders, decrypters, PPV players, interface programs to STB, interface programs to a television, video camera, and so forth. Mass storage may further include applications such as Content Protection Manager (CPM) 252. CPM 252 may include additional components that may be configured to create a fingerprint (fingerprint manager 253) and perform a classification of a pattern (classifier 254). CPM 252 may also include decision engine 255 that, among other things, may be configured to analyze a variety of factors that could indicate an abnormal behavior. When an abnormal behavior is detected, decision engine 255 may take an action to protect the content from potentially unauthorized acts. CPM 252 and its associated components may perform actions that are described in more detail below in conjunction with FIGS. 4-6.

In one embodiment, CPM 252 is loaded onto computing device 200 in conjunction with content. As such, CPM 252 may reside on the content media, such as a CD, DVD, and the like. CPM 252 may also be loaded across a network while the content is downloaded onto computing device 200. However, the invention is not so limited, and CPM 252 may be loaded onto computing device 200 employing virtually any mechanism, and at virtually any time, even independent of when the content is loaded. Moreover, although FIG. 2 illustrates CPM 252 residing within computing device 200, the invention is not so constrained, and CPM 252 may reside on another device, be distributed across multiple devices, and the like, without departing from the scope or spirit of the invention.

Computing device 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion.

Computing device 200 also includes input/output interface 224 for communicating with external devices, such as a mouse, keyboard, scanner, or other input devices not shown in FIG. 2. Likewise, computing device 200 may further include additional mass storage facilities such as CD-ROM/DVD-ROM drive 226 and hard disk drive 228. Hard disk drive 228 may be utilized to store, among other things, application programs, databases, client device configuration information, policy, and the like.

Illustrative Overview of Operations

The invention is enabled to monitor and detect unauthorized behavior and to minimize the impact of such behavior on a system, on content, and the like. As such, the invention is directed towards monitoring unauthorized behavior, whether it be from an source outside or remote from the computing system, or even an inside the computing system (e.g., where the source may be an end-user of the computing system, a process, program, or similar task running on the computing system, or the like.)

The invention is further designed to detect unauthorized behavior on a computing system that could be indicative of behavior directed at intercepting, capturing, copying, and/or modifying content using any of a variety of concepts, including fingerprinting, pattern recognition, statistical analysis, and the like. Protection of the content may then be achieved by terminating the unauthorized process or task, interfering with the unauthorized process or task, or even shutting down the content through a variety of mechanisms such that the content may no longer be available to the unauthorized process or task.

In employing these concepts, authorized actions observed on a computing system may be classified as a “normal” pattern of actions, or behaviors. Actions that attempt to make an unauthorized act may alter this pattern of “normal” behavior. Such altered behavior pattern is likely not to match the normal pattern. These altered behavior patterns may be termed ‘abnormal’ or ‘bad’ behavior.

Determination of normal behavior may be based, in part, on classifying of behaviors that may be transformed from data related to a set of characteristics for a process or subset of a process executing on the computing system, independent of a name associated with each process. Such data may be obtained from the computing system, for example, during execution of a content player, and the like.

The invention is further directed towards determining a logical, non-numerical difference between the considered “normal” behaviors for each process from “abnormal” behavior. The determination may be for real time, as well as for non real time.

Based on one approach, monitoring is directed towards the gathering of information and characteristics related to existing processes on computing system. However, there are potentially hundreds of different possible parameters, which may characterize each single process. This could result in a time and resource extensive analysis. For example, consider where each process includes about 200 potential parameters that may be monitored, as it may be realized, for example, on one embodiment of a Windows 2000 Professional operating system. Then, analysis may have to be performed over a 200×K data space, where K is a number of running processes on the computing system. However, given a sufficient space, and resources, this approach may be performed by the invention, and is thus, not outside of the scope of the present invention.

However, collected data may also be arranged to minimize the number of parameters employed for analysis. Thus, in one embodiment, the invention employs a delta events approach that is based, in part, on measuring differences between each parameter that may characterize a process over a period of time. The obtained differences may be considered as special events of parameter behaviors, termed herein as a fingerprint.

Moreover, some parameters for a given process may change its value over time, while others may not. This observation may be employed in development of the processes' fingerprints. That is, a parameter may, or may not vary substantially, within a given time period. This may be employed to simplify the monitoring of a parameter to determine whether it has changed or remained substantially the same during a period of time. Thus, the parameter may be represented as having one of two states: changed or unchanged. Each process parameter may then be considered to have its own state of behaviors that may be transferred to the fingerprint or pattern of behavior. Furthermore, each process can be characterized as a pattern of patterns of behaviors or fingerprints. By employing a two state representation of an action of a parameter, the invention may transform a digital parametrical approach into a non-numeric logical task.

However, not every parameter may have just one state. A parameter might, for example, be in multiple states over time. The probability for an appearance of each state of the parameter, however, may be obtained by statistical analysis. If such statistical analysis indicates that an appearance of one state is substantially exceeded by an appearance of another state, a determination may be made of a mathematical expectation (e.g., an arithmetic mean) for each state. Then, a count of obtained abnormalities for the parameter may be determined to be noise or uncertainty.

Selection of which processes to monitor may be based on any of a variety of considerations. For example, one may select to monitor processes associated with playing of content, processes associated with hacking, and the like. In one embodiment, parameters are selected that are associated with the processor kernel. In another embodiment, an analysis is performed on processes associated with the processor kernel, and also user times for running processes. Those processes determined to have times substantially greater than other processes may be selected for continued analysis.

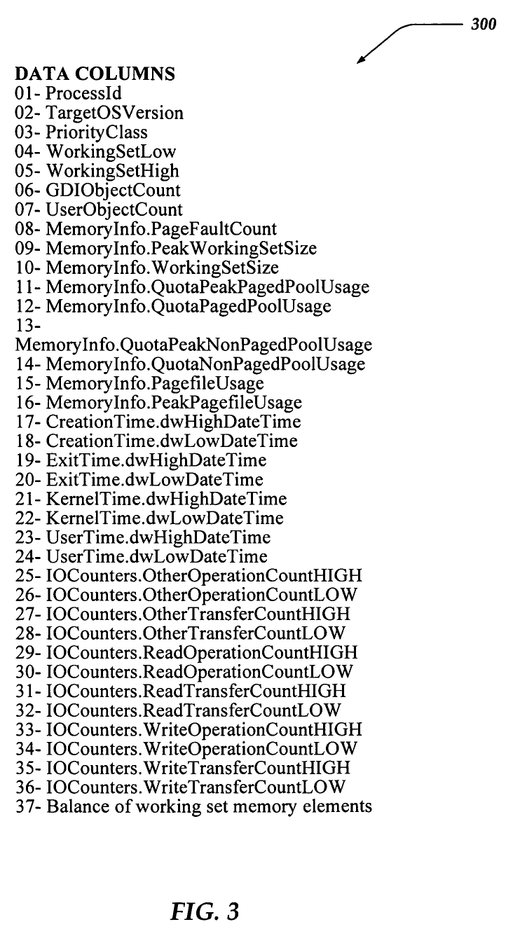

For example, based on one embodiment, a mathematical analysis may indicate that for a given operating system, such as a predetermined version of Windows, statistically 37 parameters out of 200 that characterize each single process may have a major influence on the behavior patterns. FIG. 3 illustrates one example of a set of parameters that may be employed in one embodiment of the invention based, at least in part, on the analysis. The invention, however, is not limited to these parameters, and others may be employed, without departing from the scope of the present invention.

After the selection of a set of parameters, a set of classes with borders may be created. For example, two classes, a good behavior class, and a bad behavior class may be represented by two patterns of behavior. The first (the good behavior) may be associated with a content player, and the like, and the other (the bad behavior) may be associated with an unauthorized action, such as from any of a variety of hacking tools, including such as screen scrapers, audio capture programs, and the like.

The pattern that represents the content player can be obtained by calculating a mathematical expectation based on execution of the content player over several time periods, and performing an analysis of processes associated with the content player. A similar approach may be employed for determining the pattern associated with the hacking tools.

An ideal border may be generated for each class, where an ideal bad class may include unchanged data only, and an ideal good class may include only the changed data. In one embodiment, such ideal borders may be obtained from behavior analysis of single patterns related to the content player and/or to the hacking tool, or the like.

An analysis may be performed on the obtained prototype patterns to select a set that is then provided to the decision engine. In one embodiment, the obtained prototype patterns may be reduced by selection of a subset, such as between two to four patterns (although the invention is not limited to such a reduced set). The obtained prototype patterns may be compared to a good pattern so that a worse case may be established. Similarly, the prototype patterns may be compared to a bad pattern so that a selection may be made of a pattern that most closely represents the bad pattern. In still another embodiment, where decision engine 255 may be configured to operate on a balancing principle, where one set of patterns, or class, includes only a good pattern score, while another set of patterns, or class, includes only a bad pattern score.

Each of the two scale classes may be loaded a priori with an equal number of good and bad scores. In one embodiment, a scale is established that is initially zeroed. The good score and bad score associated with the selected classes, represent a total possible score that might occur in the each class. When a new score is obtained, the invention may add it to one of the scale classes. As one is added to a class, another is subtracted from the other class, automatically. This is directed towards maintaining substantially the same total score number, without creating a substantial misbalance.

Should a misbalance arise, for example, based on a bad score, the invention determines values and classifications from the decision engine. This determination is performed for misbalances of bad score, rather than for good scores, as a bad situation is what the invention seeks to identify, and by not performing it for good scores, processing time may be minimized.

Data entropy may be determined for each class based in part on a determination of values employing, for example, a non-linear classification rule, or the like. In one embodiment, base two logarithmic data entropy is employed to determine an output from the decision engine. Then, when the results of the output are significantly equal to or larger then a predetermined confidence level the decision engine is configured to respond with the final conclusion.

In preparation for determining process characteristics a number of events and sample size for the data to be collected is determined. The number of events includes a desired maximal number of different process parameters and characteristics that may be obtained from a given operation system configuration. For example, such parameters may include, but not be limited to Process ID, Target OS Version, Priority Class, User Object Count, Memory Info, IO Counters, and the like.

The sample size includes a size of data samples typically employed for processing that may be extracted from the number of available events. Any of a variety of statistical approaches may be employed to significantly reduce the sample size used to perform the pattern recognition task.

Illustrative Operations for Detecting an Unauthorized Behavior

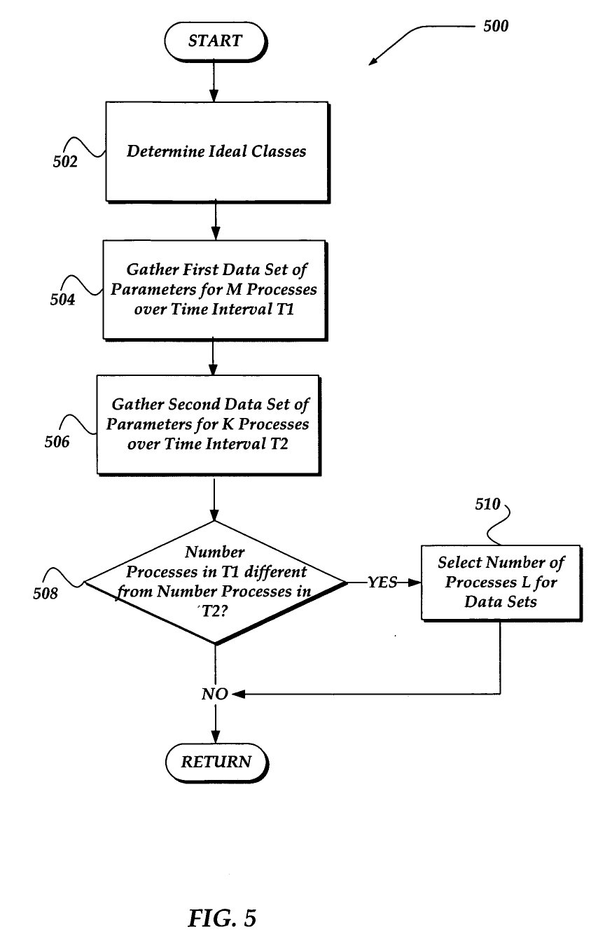

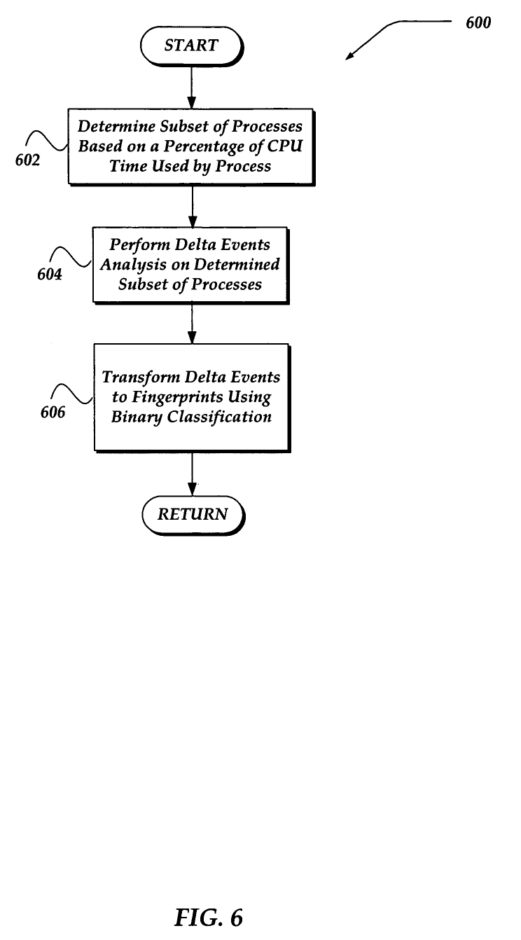

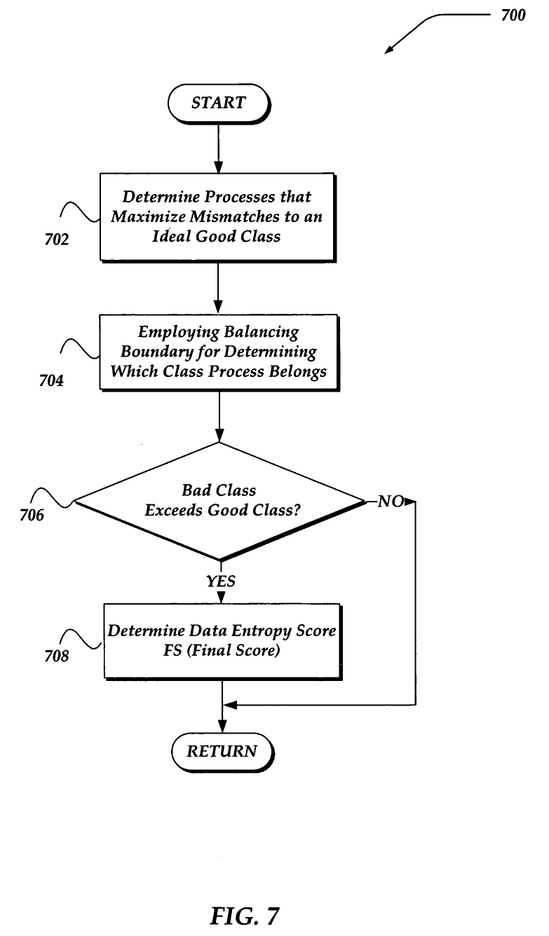

The operation of certain aspects of the invention will now be described with respect to FIGS. 4-6. In particular, FIG. 4 illustrates an overview process for detecting an unauthorized behavior on a computing device. The process, as described herein includes several sub-processes, including a sub-process for the collection of data on pre-selected parameters for various processes that may be executing on the computing device, a sub-process for determining fingerprints based on a delta events analysis, and a sub-process for classifying the fingerprints using entropy analysis. FIG. 5 illustrates the data collection sub-process. FIG. 6 illustrates the fingerprint determination sub-process, and FIG. 7 illustrates the classification process. Each of these processes is described in more detail below. Moreover, the operation is described in further detail, following the discussion of the logical flow diagrams.

FIG. 4 illustrates a logical flow diagram generally showing one embodiment of an overview process for detecting an unauthorized behavior on a computing device, such as clients 106-108 of FIG. 1. Process 400 of FIG. 4 may be implemented in software, hardware, a combination of hardware, or the like, operable upon the computing device.

Process 400 begins, after a start block, at block 402, which is described in more detail below in conjunction with FIG. 5. Briefly, however, at block 402, a collection is performed of pre-selected parameters for various processes that may execute on the computing device. Examples of such pre-selected parameters were described above, in conjunction with FIG. 3. In one embodiment, the collection process includes collection of pre-selected parameters for at least two time intervals.

Processing then continues to block 404, which is described in more detail below in conjunction with FIG. 6. Briefly, however, at block 404, fingerprints are determined for at least a subset of the processes that may be executing on the computing device. The fingerprints may be determined using a delta events analysis described in more detail below.

Process 400 then continues to block 406, which is described in further detail below in conjunction with FIG. 7. Briefly, at block 406, the determined fingerprints may be classified into bad and/or good behavior patterns using an entropy analysis. The entropy analysis may then determine an entropy of the processes being evaluated on the computing device.

Processing flows next to decision block 408, where a determination is made whether unauthorized behavior is detected. As described further below, this determination may be made based on comparing the determined entropy to a predetermined confidence level. If it is determined that the determined entropy is above the predetermined confidence level, then it may be stated that unauthorized behavior is present, and processing flows to block 410; otherwise processing loops back to block 402 to continue to monitor for a presence of unauthorized behavior on the computing device.

At block 410, various predetermined actions may be performed based on a business policy, or the like. For example, such predetermined actions may include turning off a network connection, turning off one or more processes, destroying or otherwise inhibiting access to content, inhibiting access to the computing device, providing a message, alert, or the like to one or more entities, or the like. Virtually any action may be performed based on detection of unauthorized behavior.

Processing may then return to a calling process. However, the invention is not so limited. For example, although process 400 illustrates returning to the calling process, process 400 may also loop back to block 402 after block 410, and continue to monitor for unauthorized behavior, without departing from the scope or spirit of the invention.

FIG. 5 illustrates a logical flow diagram generally showing one embodiment of a process for gathering pre-selected parameters of processes associated with the computing device. FIG. 5 illustrates one embodiment of a sub-process of operations for block 402 described above in conjunction with FIG. 4.

Process 500 of FIG. 5 begins, at block 502, where ideal classes are established. In one embodiment, an ideal good class and an ideal bad class are determined. For example, the ideal good class may be represented by a matrix with all 1s, while the ideal bad class may be represented by a matrix with all −1s.

Processing then proceeds to block 504, where a first data set of parameters for M processes is collected over a first time interval T1. Such data collection may include monitoring the set of parameters for each of M processes and recording their respective values over time interval T1. The data set may be stored using any of a variety of mechanisms, including a folder, spreadsheet, memory, a database, a document, or the like. Moreover, the set of parameters may include any of a variety of parameters associated with the M processes that may be executing on the computing device.

Process 500 continues to block 506 where a second data set of parameters for K processes is collected over a second time interval T2. The first and second data sets of parameters may be obtained for virtually every process of interest executing on the computing device. However, the invention is not constrained to the collecting of data sets for every process. For example, a subset of processes may be selected for collection, without departing from the scope or spirit of the invention. In one embodiment, the data collection of block 506 may be performed after a delay.

Moreover, the first and second data sets may be represented as matrices, which are described in more detail below. Briefly, however, the matrices may include the set of parameter values over time for each of the M or K processes.

Processing then flows from block 506 to decision block 508 where a determination is made whether the number of processes M collected during T1 is the same as the number of processes K collected during T2. That is, does M=K? M and K may not be equal, for example, in situations where a process executes during one interval and does not execute during the other interval of data collection. For example, a spell checker process may be executed during one interval and not another. Thus, if it is determined that M is different from K, then processing flows to block 510. At block 510, a selection of data of parameters associated with a number of the processes L for the two intervals is selected. In one embodiment, the number of processes is determined by selecting those processes that were executing during both intervals. For example, the number of processes L may be min (M, K). This enables the two data sets to be of the same dimensional size. Processing then returns to a calling process to perform other actions. Similarly, if M=K at decision block 508, processing also returns to a calling process to perform other actions.

FIG. 6 illustrates a logical flow diagram generally showing one embodiment of a process for employing delta events analysis to determine fingerprints for some or all of the processes. The mathematics behind process 600 of FIG. 6 is described in more detail below. Moreover, process 600 may represent one embodiment of block 404 of FIG. 4.

Process 600 begins, after a start block, at block 602, where a subset of the processes for which data sets where collected is determined. Any of a variety of mechanisms may be employed to determine the subset of processes. As illustrated, however, the subset is determined by selecting those processes for which a high percentage of CPU time was used. In one embodiment, this may be determined, for example, by monitoring those processes for which parameters 21 and 23 of FIG. 3 indicate a high percentage of CPU time. In one embodiment, the high percentage of CPU time is a maximum of percentage of CPU time. However, the invention is not so constrained, and other parameters, or the like, may be employed. In any event, once a subset of the processes is determined, processing flows to block 604.

At block 604 delta events analysis is performed on the subset of processes. Briefly, delta events analysis may include subtracting the two data sets of the subset of processes to obtain a delta data set of processes. As mentioned earlier each data set may represent a process by parameter matrix, or the like and that the parameter variations may further represent patterns of behaviors for the processes.

Processing then continues to block 606 where the delta events data set is transformed into fingerprints for the processes by using a binary classification as described in more detail below. Briefly, such binary classification may be viewed as transforming the numeric decision into a non-numeric logical decision. Process 600 then returns to a calling process.

FIG. 7 illustrates a logical flow diagram generally showing one embodiment of a process for performing pattern classification of the determined fingerprints using entropy analysis. Process 700 of FIG. 7 may represent, for example, one embodiment of block 406 of FIG. 4 above.

Process 700 begins, after a start block, at block 702, where processes that maximize mismatches to an ideal good class is determined. This is described in more detail below. Briefly, however, consider the ideal good class to be, for example, a set of all ones ([1, 1 . . . 1]). Then a comparison may be made between each element within the ideal good class set, and each element within each process set that was obtained from Process 600 of FIG. 6, or the like. An element by element count may be performed, of which a sum of the results of the comparison may indicate which processes maximize the mismatch (e.g., are furthest from the ideal good class). In one embodiment, the worse processes (i.e., identify another subset of processes within the subset of processes that result in the largest mismatch from the ideal good class).

Processing then continues to block 704, where a balancing scheme is employed upon the subset of processes determined at block 702. The balancing scheme results in classifying each pattern of behaviors (processes) into good classes and bad classes, and determining a count of such patterns within each of the two classes, according to the balancing rules below.

Processing then flows to decision block 706 where a determination is made whether the number of patterns counted in the bad class exceeds the number of patterns counted in the good class. If it does, processing flows to block 708; otherwise, processing returns to a calling process.

At block 708 a final score entropy is determined, as described in more detail below. Processing then returns to a calling process. In one embodiment, the calling process may then apply a statistical test to the final score entropy to determine whether, within a predetermined confidence level, an unauthorized behavior is detected.

It will be understood that each block of the flowchart illustration, and combinations of blocks in the flowchart illustration, can be implemented by computer program instructions. These program instructions may be provided to a processor to produce a system, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor, provide the steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or a combination of special purpose hardware and computer instructions might be used to perform the specified actions.

Pattern Classification

The following provides further detail on the invention and may be employed to further describe the processes described above in conjunction with FIGS. 4-7.

For example, the following describes the pattern classifications and data collection actions of FIG. 5, above.

Consider a number of events as a set of single patterns that characterize each of the existing processes on a computing system of interest. This set can be obtained after monitoring the computing system, as described above, for the time period T1.

The number of events may be described as a pattern of patterns by employing a vector Xᵢ in N-dimensional Euclidean measurement space R^{N}, where a parameter i=1, N represents a number of single patterns as components of the vector Xᵢ:
Xᵢ=(X_{i,1}, X_{i,2}, . . . , X_{i,N-1}, X_{i,N})

If there are M processes running simultaneously (that is, M vectors Xᵢⱼ, i=1, N and J=1, M), they can be represented by a matrix A:

$$A = \vert \begin{matrix}{X}_{1 , 1} & {X}_{1 , 2} & ⋯ & {X}_{1 , N - 1} & {X}_{1 , N} \\ {X}_{2 , 1} & {X}_{2 , 2} & ⋯ & {X}_{2 , N - 1} & {X}_{2 , N} \\ {X}_{3 , 1} & {X}_{3 , 2} & ⋯ & {X}_{3 , N - 1} & {X}_{3 , N} \\ ⋯ & ⋯ & ⋯ & ⋯ & ⋯ \\ ⋯ & ⋯ & ⋯ & ⋯ & ⋯ \\ {X}_{M - 1 , 1} & {X}_{M - 1 , 2} & ⋯ & {X}_{M - 1 , N - 1} & {X}_{M - 1 , N} \\ {X}_{M , 1} & {X}_{M , 2} & ⋯ & {X}_{M , N - 1} & {X}_{M , N}\end{matrix} \vert$$

Another set can be obtained after monitoring the computing system for time period T2, as described above. The new number of events can be introduced as a pattern of patterns by the vector Yᵢ in N-dimensional Euclidean measurement space R^{N}, where the parameter i=1, N represents a number of single patterns as components of the vector Yᵢ:
Yᵢ=(Y_{i,1}, Y_{i,2}, . . . , Y_{i,N-1}, Y_{i,N})

If there are K processes running simultaneously within the computing system (there are K vectors Y_{i,j}, i=1, N and J=1, K), they can be represented by the matrix B:

$$B = \vert \begin{matrix}{Y}_{1 , 1} & {Y}_{1 , 2} & ⋯ & {Y}_{1 , N - 1} & {Y}_{1 , N} \\ {Y}_{2 , 1} & {Y}_{2 , 2} & ⋯ & {Y}_{2 , N - 1} & {Y}_{2 , N} \\ {Y}_{3 , 1} & {Y}_{3 , 2} & ⋯ & {Y}_{3 , N - 1} & {Y}_{3 , N} \\ ⋯ & ⋯ & ⋯ & ⋯ & ⋯ \\ ⋯ & ⋯ & ⋯ & ⋯ & ⋯ \\ {Y}_{K - 1 , 1} & {Y}_{K - 1 , 2} & ⋯ & {Y}_{K - 1 , N - 1} & {Y}_{K - 1 , N} \\ {Y}_{K , 1} & {Y}_{K , 2} & ⋯ & {Y}_{K , N - 1} & {Y}_{K , N}\end{matrix} \vert$$

Three possible situations are considered regarding parameter K: first K=M; second K>M; and third K<M. Monitoring of these situations enables the invention to properly perform computations employing matrices A and B. In one embodiment, a comparison is performed on virtually all processes that executed during both time period T1 and time period T2 by comparing matrices A and B. The matrices are ordered using the previously determined process parameters used to uniquely identify each process (ID).

If it is determined that they are the same and no additional entries appear, then it indicates that that M=K and computations employing matrices A and B may be performed. In the situation where M>K (such as where a earlier executing process has terminated), or in the situation where M<K (such as where an non-executing process has starting execution), a subset of IDs that is common to both matrices A and B, may be determined and employed in later calculations.

Determining Fingerprints Using Delta Events Analysis

The following further elaborates on process 600 of FIG. 6. As was mentioned above, it is possible to make a reduction of a dimension for each vector that represents a certain process from size N to the size L, where N>L. The number of events can be introduced, for example, as a pattern of patterns by vector Xᵢ or Yᵢ in L-dimensional Euclidean measurement space R^{L}, where the parameter i=1, L is a number of single patterns as components of the vector Xᵢ or Yᵢ.

It is possible to reduce the number of considered vectors by choosing those parameters that are using a CPU % of time that is greater than some selected value P %, wherein P % may be selected based on a variety of conditions. For example, in one embodiment, P % may be selected based on a CPU used by a player.

A user time Ut may be defined as a difference between two values representing the amount of time reported by the O/S that the process spent executing in user mode at different T2 and T1 time intervals. A kernel time Kt may also be defined as a difference between two values representing the amount of time reported by the O/S that the process spent executing in the kernel at the same T2 and T1 time intervals. Then a calculation of CPU % can be determined from vector Vuk:
Vuk=(Kt_{1,i-1}+Ut_{1,i}; Kt_{2,i-1}+Ut_{2,i}; . . . ;
Kt_{j,i-1}+Ut_{j,i}; . . . ; Kt_{M,i-1}+Ut_{M,i})^{T}

where the index M represents a total number of executing processes; j is a current process; index i represents a process event i-1 and i of the process j. The events i-1 and i are employed to maintain values associated with the kernel, and user time, respectively. A selection of the various indices may be associated with a particular computer operating system, or the like.

Then the percentage of CPU % time for each j-running process can be determined as a part of the sums (Kt_{j,i-1}+Ut_{j,i}), where j=1, M:

$$CPU {\%}_{j} = ( ( {Kt}_{j , i - 1} + {Ut}_{j , i} ) / {\sum }_{j = 1}^{M} ( {Kt}_{j , i - 1} + {Ut}_{j , i} ) ) * 100 \%$$

After determining all CPU % a determination is made of a number of processes NP that used CPU % time greater than chosen value P %, where NP<<M.

In a real system the variance of value NP is typically between 2 and 4, although this is not required.

Based on the above, and a new maximum matrix size, the invention may reduce the computations to a 4×37 problem.

Then, given two new matrices A1 and B1 with a same rank, and where A1 is obtained from the time interval T1 and B1 is obtained from the time interval T2:

$$A 1 = \vert \begin{matrix}{X}_{1 , 1} & {X}_{1 , 2} & ⋯ & {X}_{1 , N 1 - 1} & {X}_{1 , N 1} \\ {X}_{2 , 1} & {X}_{2 , 2} & ⋯ & {X}_{2 , N 1 - 1} & {X}_{2 , N 1} \\ {X}_{3 , 1} & {X}_{3 , 2} & ⋯ & {X}_{3 , N 1 - 1} & {X}_{3 , N 1} \\ {X}_{4 , 1} & {X}_{4 , 2} & ⋯ & {X}_{4 , N 1 - 1} & {X}_{4 , N 1}\end{matrix} \vert$$

$$B 1 = \vert \begin{matrix}{Y}_{1 , 1} & {Y}_{1 , 2} & ⋯ & {Y}_{1 , N 1 - 1} & {Y}_{1 , N 1} \\ {Y}_{2 , 1} & {Y}_{2 , 2} & ⋯ & {Y}_{2 , N 1 - 1} & {Y}_{2 , N 1} \\ {Y}_{3 , 1} & {Y}_{3 , 2} & ⋯ & {Y}_{3 , N 1 - 1} & {Y}_{3 , N 1} \\ {Y}_{4 , 1} & {Y}_{4 , 2} & ⋯ & {Y}_{4 , N 1 - 1} & {Y}_{4 , N 1}\end{matrix} \vert$$

A new matrix C1, may be determined as:

$$C 1 = B 1 - A 1 or C 1 = \vert \begin{matrix}{Z}_{1 , 1} & {Z}_{1 , 2} & ⋯ & {Z}_{1 , N 1 - 1} & {Z}_{1 , N 1} \\ {Z}_{2 , 1} & {Z}_{2 , 2} & ⋯ & {Z}_{2 , N 1 - 1} & {Z}_{2 , N 1} \\ {Z}_{3 , 1} & {Z}_{3 , 2} & ⋯ & {Z}_{3 , N 1 - 1} & {Z}_{3 , N 1} \\ {Z}_{4 , 1} & {Z}_{4 , 2} & ⋯ & {Z}_{4 , N 1 - 1} & {Z}_{4 , N 1}\end{matrix} \vert$$

where Z_{j,i}=Y_{j,i}−X_{j,i}; i=1, N1; j=1,4.

The invention is not constrained to such values for i and N1, however. For example, in one embodiment, a further reduction of the vector size to 15 (N1=15) may be performed, without a significant loose of relevant information.

A transformation of matrix C1 to a binary classification form may be determined, where each matrix element is determined as binary value. In one embodiment, this may be achieved by substituting each element Z_{j,i} of matrix C1 by W, where W is an arbitrary logical weighting coefficient:

$${Z}_{j , i} ⋃ W = \{ \begin{matrix}1 , & if {Z}_{j , i} \neq 0 \\ - 1 , & if Zj , i = 0\end{matrix}$$

The result is that matrix C1 includes elements such as 1, −1. Moreover, the resulting matrix C1 represents fingerprints for the processes. However, the invention is not constrained to these values, and virtually any other value, set of values, and the like, may be employed, without departing from the scope or spirit of the invention.

Classification of Fingerprints Using Entropy Analysis

The following further elaborates on process 700 of FIG. 7. To determine a score to be provided to the decision engine, an expression, for example, in expanded form for 4 vectors in N1-dimensional space may be determined, using:
C1*PV^{T}=D

Where is PV^{T} is a pattern vector with the components PV₁, PV₂, . . . , PV_{N1}, and D is an output vector with components D₁, D₂, D₃, and D₄, such that:

$$\vert \begin{matrix}{Z}_{1 , 1} & {Z}_{1 , 2} & ⋯ & {Z}_{1 , N 1 - 1} & {Z}_{1 , N 1} \\ {Z}_{2 , 1} & {Z}_{2 , 2} & ⋯ & {Z}_{2 , N 1 - 1} & {Z}_{2 , N 1} \\ {Z}_{3 , 1} & {Z}_{3 , 2} & ⋯ & {Z}_{3 , N 1 - 1} & {Z}_{3 , N 1} \\ {Z}_{4 , 1} & {Z}_{4 , 2} & ⋯ & {Z}_{4 , N 1 - 1} & {Z}_{4 , N 1}\end{matrix} \vert * \vert \begin{matrix}{PV}_{1} \\ ⋯ \\ ⋯ \\ {PV}_{N 1}\end{matrix} \vert = \vert \begin{matrix}{D}_{1} \\ {D}_{2} \\ {D}_{3} \\ {D}_{4}\end{matrix} \vert$$

To maintain a score value in a binary format, a rule, such as the following may be employed:

$$min ( D ) = min ( {D}_{1} , {D}_{2} , {D}_{3} , {D}_{4} ) = \{ \begin{matrix}1 , & if min ( D ) < 0 \\ - 1 , & if min ( D ) > 0\end{matrix}$$

Next, the pattern may be classified by identifying relevant features in the original information, extracting such features, and measuring them. These measurements may then be passed to a classifier, which may classify the pattern.

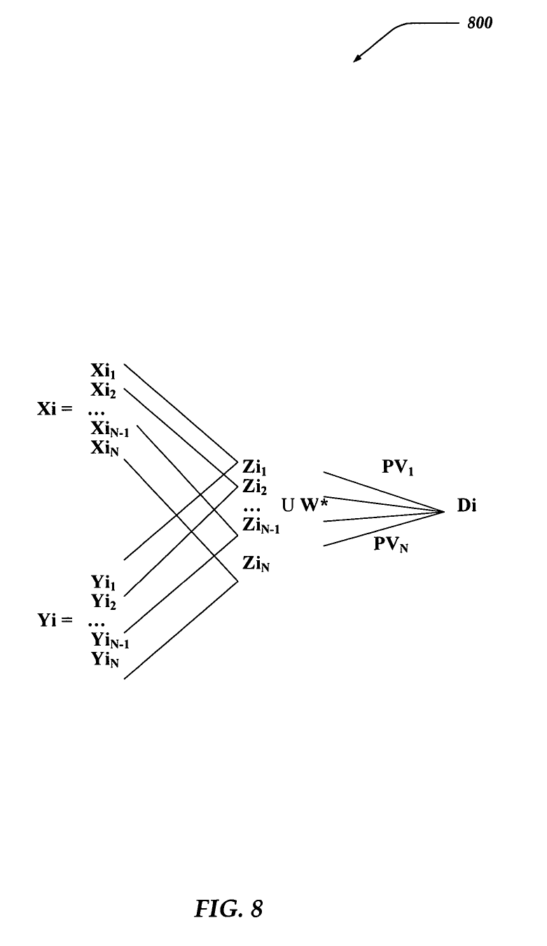

FIG. 8 illustrates a schematic representation 800 generally showing one embodiment of a process of transforming two vectors Xi and Yi to one score output

(Zi^{T}∪W)*PV=Di. As shown in the figure, vectors Xi and Yi represent input data. Similarly, vector Zi=(Zi₁, Zi₂, . . . , Zi_{N}) represents Delta events. Furthermore, coefficient W represents an arbitrary weight (as was shown above), and vector PV=(PV₁, PV₂, . . . , PV_{N}) representing the ideal pattern vector. For example, assuming that 1 is an ideal value, then PV might be (1, 1, . . . 1). However, the invention is not so constrained and PV may also be represented by other values. The single value Dᵢ represents the total output result of the transformation of two vectors Xᵢ and Yᵢ.

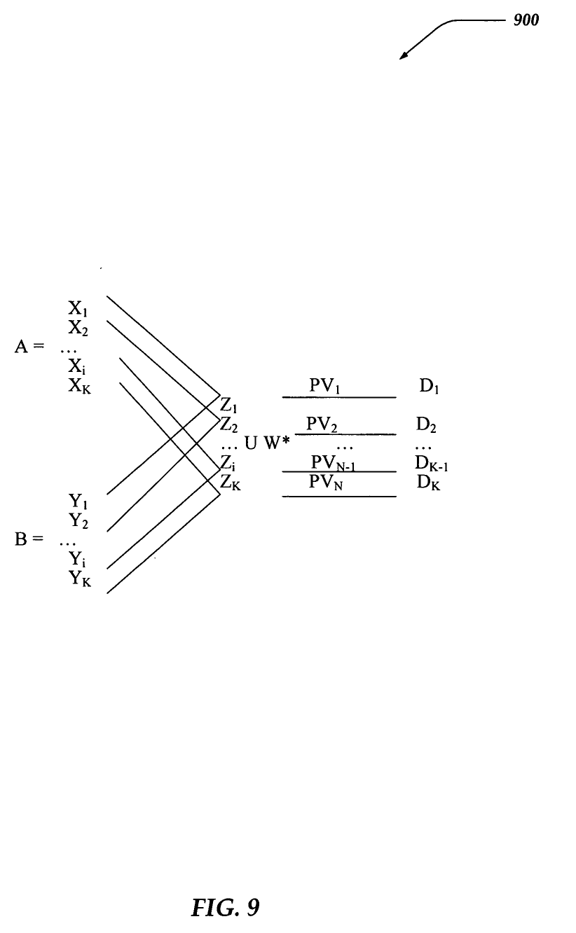

FIG. 9 illustrates a schematic representation generally showing one embodiment of a process of transforming matrices to determine several score outputs, in accordance with the invention. In particular, as shown in the figures, schematic 900 illustrates a transformation of matrices A and B to the several different score outputs, D, based on the transformation:

(Z∪W)*PV^{T}=D. As shown, matrices A and B are input to the transformation. Matrix Z represents a matrix of Delta events, and W is a matrix of arbitrary weight coefficients. Additionally, vector PV=(PV₁, PV₂, . . . , PV_{K}) represents an ideal pattern vector. The total output result of the transformation is represented by vector D=(D₁, D₂, . . . , Dₖ).

Moreover, the K N-dimensional vectors Xi, Yi, and Zi, where i=1, K, represents the matrices A, B, and Z respectively.

Where the number of classes is known and when training patterns are such that there is a geometrical separation between the classes, then a set of decision functions (DF) may be employed to classify an unknown pattern.

For example, consider a case where two classes C1 and C2 exist in Rⁿ dimensional space and a hyper line D(X)=0, which separates the associated patterns is found. Then DF D(X) may be employed as a classifier to classify each new pattern. This may be applied based on:
D(X)>0→εC1
D(X)<0→εC2

The hyper line D(X)=0 is sometimes known as a decision boundary. There also may exist linear or nonlinear classifiers, which relate to the linear or nonlinear DF, respectively. The task is to identify which kind of DF to employ to obtain a significantly reliable result.

The decision engine may be implemented employing a variety of mechanisms. In one embodiment, the decision engine employs a decision function with a nonlinear classifier that is based on a determination of a reverse entropy RE for classes C1 and C2 combined. That is:
RE=1−NE,

where NE is a normal entropy. This approach employs fuzzy and neurological mechanisms. However, the invention is not limited to this approach, and others may be employed without departing from the scope or spirit of the invention.

A balance principle may be employed for the classifier and a natural logarithmic function log₂ for an entropy determination. If the good and bad values are in about equal balance, then the entropy for this situation is about equal to 0 and the hyper point D(X)=0 may be used as a decision boundary that separates the two classes C1 and C2.

In one embodiment the number of good data values that are initially collected in class C1 is about equal to the number of bad data values that are collected in class C2. Additionally, a total sum of the number of good data values and bad data values may remain constant and equal to the value VS.

As a data score is received from block 704 it is associated with its appropriate class, C2 or C1, based on whether it is bad or good data. In a first situation, receipt of data results in an increase by one of the amount of data in that class. To maintain a total value VS at substantially a constant value, the number of data is decremented for the other class. Then a comparison is performed between the numbers for classes C1 and C2. When it is determined that the number of the bad data BN in the class C2 is substantially larger then number of good data GN in the class C1 (that is D(X)>0), a final score FS is determined from the decision engine based on:
FS=1+(BN/VS)* log₂(BN/VS)+(GN/VS)* log₂(GN/VS)

Furthermore, the final score FS represents the entropy for the pattern of the processes being evaluated.

A confidence level may be assigned with a value CL in the scale from about 0 to about 1, inclusive. Then a final decision about tested pattern is made when either
FS≧CL

Similarly, the final decision may be based on a percentage measurement:
FS %=FS*100%

Thus, if the determined that the computed maximal error is within the assigned error range (confidence level) then the results are determined to be sufficiently reliable, to decide whether unauthorized behavior has been detected. Based on the detection, any of a variety of actions may then be taken to minimize access to the content, including, but not limited to deleting the content, locking the computer, inhibiting execution of a suspected program, sending an error message, and the like.

The above specification, examples, and data provide a complete description of the manufacture and use of the composition of the invention. Since many embodiments of the invention can be made without departing from the spirit and scope of the invention, the invention resides in the claims hereinafter appended.

1. A method for detecting an unauthorized behavior on a computing device, comprising:
selecting a plurality of parameters associated with each process in a plurality of processes on the computing device;
collecting data for the plurality of parameters associated with each process in the plurality of processes;
using delta events to determine fingerprints for at least a subset of the plurality of processes;
dynamically determining an entropy for the subset of the plurality of processes; and
if the determined entropy indicates unauthorized behavior on the computing device, performing a predetermined action.

2. The method of claim 1, wherein selecting the plurality of parameters further comprises selecting the plurality of parameters based on a characteristic of the computing device, including at least one of an operating system characteristic, a memory characteristic, or an input/output (I/O) device characteristic.

3. The method of claim 1, wherein the plurality of parameters include at least one of a memory metric, a kernel metric, a resource usage metric, a time metric, an input/output metric, and a size metric associated with at least one process configured to execute on the computing device.

4. The method of claim 1, further comprising:
determining the subset of the plurality of processes by selecting processes within the plurality of processes consuming a central processor unit's (CPU's) resource of the computing device.

5. The method of claim 4, wherein the CPU's resource further comprises a percentage of CPU time.

6. The method of claim 1, wherein collecting data for the plurality of parameters further comprises:
generating a first data set by recording the plurality of parameters for a first time interval; and
generating a second data set by recording the plurality of parameters for a second time interval.

7. The method of claim 6, using delta events to determine fingerprints further comprises:
subtracting the first data set from the second data set to generate a data set of differences, wherein the subtraction is based on a same process and a same parameter within the first and second data sets; and
transforming the data set of differences to a binary data set using a logical weighting coefficient, the binary data set representing fingerprints for each of the processes within the subset of the plurality of processes.

8. The method of claim 7, wherein subtracting further comprises:
if the first data set and the second data set differ in a number of processes, selecting a common set of processes between the first data set and the second data set prior to performing the substraction.

9. The method of claim 1, wherein dynamically determining an entropy further comprises determining the entropy based on at least one of an analytical, fuzzy, or neurological mechanism.

10. The method of claim 10, wherein dynamically determining an entropy further comprises:
determining another subset of processes within the subset of processes that maximize a mismatch with a predetermined ideal good class of parameters;
determining a number of good parameters within a first class of processes, wherein the first class of processes includes processes in the other subset of processes that are determined to be above a hyperline;
determining a number of bad parameters within a second class of processes, wherein the second class of processes includes processes in the other subset of processes that are determined to be below the hyperline; and
if the number of bad parameters is substantially greater than the number of good parameters, determining the entropy based on a logarithmic function of the number of bad parameters, number of good parameters, and a total number of good and bad parameters.

11. A method for detecting an unauthorized behavior on a computing device, comprising:
selecting a plurality of parameters associated with each process in a plurality of processes on the computing device;
collecting data for the plurality of parameters associated with each process in the plurality of processes;
determining fingerprints for at least a subset of the plurality of processes;
dynamically determining an entropy for the subset of the plurality of processes; and
if the determined entropy indicates unauthorized behavior on the computing device, performing a predetermined action.

12. The method of claim 11, wherein determining fingerprints further comprise:
employing a delta events analysis of the collected data for the plurality of parameters associated with each process within the subset of the plurality of processes, wherein the delta events analysis further comprises determining a delta of differences between each parameter within the plurality of parameters for each process common between multiple collection intervals of the data.

13. The method of claim 11, wherein dynamically determining an entropy further comprises:
selecting another subset of processes from within the subset of processes based on a percentage of CPU time used by each process in the subset of the plurality of processes;
determining processes within the other subset of processes that maximize a mismatch with a predetermined ideal good class of parameters;
determining a number of good parameters within a first class of processes, wherein the first class of processes includes processes in the other subset of processes that are determined to be above a hyperline;
determining a number of bad parameters within a second class of processes, wherein the second class of processes includes processes in the other subset of processes that are determined to be below the hyperline; and
if the number of bad parameters is substantially greater than the number of good parameters, determining the entropy based on a logarithmic function of the number of bad parameters, number of good parameters, and a total number of good and bad parameters.

14. A computer-readable medium having computer-executable components for use in detecting an unauthorized behavior in a computing device, the components comprising:
a transceiver for receiving and sending information;
a processor in communication with the transceiver; and
a memory in communication with the processor and for use in storing data and machine instructions that causes the processor to perform operations, including:
selecting at least one parameter associated with at least one process on the computing device;
collecting data for the at least one parameter for the at least one process;
determining a fingerprint for at least one process based in part on delta events in the collection of data;
dynamically determining an entropy for the at least one process; and
if the determined entropy indicates unauthorized behavior on the computing device, performing a predetermined action.

15. The computer-readable medium of claim 14, where selecting the at least one parameter further comprises selecting the at least one parameter based on a characteristic of the computing device.

16. The computer-readable medium of claim 14, further comprising:
determining the at least one process by selecting processes consuming a predetermined resource of the computing device.

17. The computer-readable medium of claim 14, wherein collecting data for the at least one parameter of the at least one process further comprises:
generating a first data set by recording the at least one parameter for a first time interval; and
generating a second data set by recording the at least one parameter for a second time interval.

18. The computer-readable medium of claim 17, determining a fingerprint based at least in part on delta events further comprises:
determining a data set of differences between the first data set and the second data set, wherein the determination is based on a same process and a same parameter within the first and second data sets; and
transforming the data set of differences to a binary data set using a logical weighting coefficient, the binary data set representing a fingerprint for the at least one process.

19. The computer-readable medium of claim 14, wherein dynamically determining an entropy further comprises:
determining a process within the at least one process that maximizes a mismatch with a predetermined ideal good class of parameters;
determining a number of good parameters within a first class of processes, wherein the first class of processes includes processes that are determined to be above a hyperline based at least in part on the collection of data;
determining a number of bad parameters within a second class of processes, wherein the second class of processes includes processes that are determined to be below the hyperline based at least in part on the collection of data; and
if the number of bad parameters is greater than the number of good parameters, determining the entropy based on a logarithmic function of the number of bad parameters, number of good parameters, and a total number of good and bad parameters.

20. A modulated data signal for use in detecting an unauthorized behavior in a computing device, the modulated data signal comprising instructions that enable the computing device to perform the actions of:
collecting a first data set over a first period for at least one parameter for each process in a plurality of processes, wherein at least one process in the plurality of processes executes on the computing device during the collection of the first data set;
collecting a second data set over a second period for the at least one parameter for each process in another plurality of processes, wherein at least one process in the other plurality of processes executes on the computing device during the collection of second data set;
selecting a set of processes from the plurality of processes and other plurality of processes;
determining fingerprints for the selected set of processes using, at least in part, a delta events analysis upon the selected set of processes;
dynamically determining an entropy for the selected set of processes; and
if the determined entropy indicates unauthorized behavior on the computing device, performing a predetermined action.

21. The modulated data signal of claim 20, wherein if the determined entropy indicates unauthorized behavior further comprises comparing the determined entropy to a confidence level.

22. The modulated data signal of claim 20, wherein dynamically determining an entropy further comprises:
determining a number of good parameters within a first class of processes, wherein the first class of processes includes processes within the selected set of processes that are determined to be above a hyperline;
determining a number of bad parameters within a second class of processes, wherein the second class of processes includes processes within the selected set of processes that are determined to be below the hyperline; and
if the number of bad parameters is substantially greater than the number of good parameters, determining the entropy based on a logarithmic function of the number of bad parameters, number of good parameters, and a total number of good and bad parameters.

23. The modulated data signal of claim 20, using delta events to determine fingerprints further comprises:
determining a set of delta differences between the first data set and the second data with respect to the at least one parameter;
transforming the set of delta differences to a binary data set using a logical weighting coefficient, the binary data set representing fingerprints for selected set of processes.

24. An apparatus for detecting an unauthorized behavior in a computing device, comprising:
means for collecting data for a parameter associated with a set of processes executing on the computing device;
means for determining a fingerprint based on the collected data and using a delta events means;
means for dynamically determining an entropy for at least a subset of the processes; and
if the determined entropy indicates unauthorized behavior on the computing device, means for performing an action.
